(19) United States
(12) Patent Application Publication
(10) Pub. No.: US 2003/0038990 A1
(43) Pub. Date: Feb. 27, 2003

(54) Convex printing table

(75) Inventor: Boris Liberman, Herzliya (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: SCITEX VISION LTD

(21) Appl. No.: 09/935,687

(22) Filed: Aug. 24, 2001

(51) Int. Cl. B41J 1/00; H04N 1/04; G06F 15/00

(52) U.S. Cl. 358/493; 358/1.15

(57) ABSTRACT

The present invention is a convex printing table for use with wide-format and super wide-format digital printers, which print on flexible substrate up to 5 meters in width. The convex profile of the table creates contact force between the flexible substrate and the support surface. This contact force lessens the formation of wrinkles in the flexible substrate during the printing process, which permits the print heads to be positioned closer to the flexible substrate than with the flat tables currently in use. The size and number of wrinkles and the distance of the print heads from the flexible substrate impact the overall quality of the finished product. The convex printing table also provides a plurality of flat printable regions, enabling use with a four-color digital printer. The print heads are deployed so as to allow all four print heads to apply printing medium simultaneously and during passes across the flexible substrate in either direction, which increases the quality of the color of the finished product.

### FIELD AND BACKGROUND OF THE INVENTION

The present invention relates to a printing table and, in particular, it concerns a convex printing table for use with wide-format and super wide-format digital printers, which print on flexible substrate up to 5 meters in width.

It is known that, at present, printing tables for wide-format and super wide-format digital printers are constructed either as a single flat surface, or from parallel support bars whose top surfaces all lie within a single plane.

It is further known that the behavior of the flexible substrate during the printing process affects the quality of the finished product. Wrinkles are a major problem. The wrinkles themselves produce flaws in the finished product. Further, the possibility that wrinkles may occur requires the print heads be positioned so as to allow for clearance of the wrinkles. This added height results in a less noticeable, yet real, distortion in the quality of the finished product.

There are further known printing tables that achieve contact force by use of a vacuum. This is accomplished by positioning small vacuum holes in the surface of the printing table, be it a single surface flat table or a table that is divided into support bars. The contact force created by the vacuum table helps only when used with impermeable substrate. There is no advantage in the vacuum table when it is used with permeable substrate materials such as net or specific types of textiles, and the constitute a large proportion of the flexible substrate used in wide-format and super wide-format digital printing. Further, there is a higher cost involved in both the manufacture and the operation of these types of tables.

There are further known printing tables that resolve the problem of wrinkles by keeping the size of the table as small as possible, which must be large enough to provide working space for at least one print head to perform its task. While this approach cuts down on the wrinkles. Digital printers using this type of table suffer problems of speed and color distortion. The slow speed occurs because in order to print using a four color process on a table only large enough for one print head to work at a time, the mechanism which moves the print heads across the flexible substrate must make four passes across the same portion of flexible substrate in order to complete the printing process. The color distortion occurs when the print medium is not applied to the flexible substrate in the same order, as the different color print heads are actuated on passes back and forth across the flexible substrate. In the CMYK color printing process, cyan and magenta together make blue. Interestingly, the blue may appear different depending on the order in which the print medium is applied to the flexible substrate, that is the cyan on top of the magenta may create a different blue than the magenta on top of the cyan. Using a method of multiple passes with different color heads on each pass, this type of color distortion is possible.

There is therefore a need for a printing table that eliminates wrinkles in the flexible substrate during the printing process, allowing the print heads to be positioned closer to the flexible substrate, and allows all print heads to apply print medium in the same pass, speeding up the process, and insuring the different colored print mediums are always applied in the same order, thus eliminating color distortion.

### SUMMARY OF THE INVENTION

The present invention is a convex printing table for use with wide-format and super wide-format digital printers, which print on flexible substrate up to 5 meters in width.

According to the teachings of the present invention there is provided, a device upon which a flexible substrate is placed in order to be printed upon, the device being configured so as to create contact force between a supporting surface of the device and the flexible substrate, the device comprising: (a) a support structure configured so as to render the flexible substrate as a plurality of adjacent flat regions, the flat regions being sequential along a feed path of the flexible substrate, each of the flat regions being positioned so that a vector following the feed path changes direction between the adjacent flat region in the sequence, the change of direction being a rotation about an axis that is perpendicular to the feed path and parallel to the surface of the flexible substrate, so that an entire surface of the plurality of flat regions, in combination, has a substantially convex profile; and (b) a tensioning device configured so as to produce tension in the flexible substrate, the tension being along the feed path.

According to a further feature of the present invention, there is also provided a digital printing device including a plurality of print heads, the support structure being configured so as to provide one the flat region for each of the printing heads.

According to a further feature of the present invention, the printing device is a digital four-color process printer using four the print heads and the support structure includes at least four the flat regions.

According to a further feature of the present invention, the support structure includes parallel support bars positioned transversely to the feed path, the support bars at least partially delineating sides of the rectangles.

According to a further feature of the present invention, the flat regions are created when the flexible substrate is placed upon the support structure, the flat regions being those portions of the flexible substrate that are stretched between the support bars.

According to a further feature of the present invention, the support structure is a substantially continuous solid surface fabricated with a plurality of the flat regions.

According to a further feature of the present invention, the tensioning device is integral to a feed and take-up device which moves the flexible substrate across the support structure.

There is provided according to a further feature of the present invention, a device for applying print media to a flexible substrate, the device comprising: (a) a support structure configured so as to have a substantially convex profile onto which the flexible substrate is placed; (b) a tensioning device configured so as to produce tension in the flexible substrate, the tension being along a feed path; and (c) a plurality of print heads deployed so as to align each of the plurality of print heads with a corresponding printing region on the flexible substrate, the print heads defining a printing plane, the printing planes being rotated in relation to one another, the printing plane including the corresponding printing region.

According to a further feature of the present invention, the support structure is configured so as to render the flexible substrate as a plurality of adjacent flat regions, the printing plane being coincidental with the flat region.

According to a further feature of the present invention, the support structure is configured so as to render the flexible substrate as a substantially continuous curve, the printing plane being tangential to the curve.

### BRIEF DESCRIPTION OF THE DRAWINGS

The invention is herein described, by way of example only, with reference to the accompanying drawings, wherein:

FIG. 1 is an isometric view of the present invention shown with flexible substrate and printer carriage;

FIGS. 2a, 2b, 2c, and 2d are schematic diagrams of the relationship between tension force and contact force, as defined in the present invention;

FIG. 3a is a cross-sectional view of a prior art flat surface printing table;

FIG. 3b is a cross-sectional view of the convex printing table of the present invention, FIG. 3c being a detail of FIG. 3b;

FIG. 4a is an isometric view of a prior art flat surface printing table shown with flexible substrate and printer carriage, FIG. 4b being a cross-section taken along the line A-A of FIG. 4a;

FIG. 5 is a cross-sectional view of the present invention showing four print heads and their respective printing planes when the flexible substrate is rendered as flat regions, FIG. 5a being a detail; and

FIG. 6 is a cross-sectional view of the present invention showing a print head and printing plane when the flexible substrate is rendered as a continuous curve.

### DESCRIPTION OF THE PREFERRED EMBODIMENTS

The present invention is a convex printing table for use with wide-format and super wide-format digital printers, which print on flexible substrate up to 5 meters in width.

The principles and operation of a convex printing table according to the present invention may be better understood with reference to the drawings and the accompanying description.

It is an intention of the present invention to provide a support structure that facilitates the creation of contact force between the support structure and the flexible substrate while supporting the flexible substrate during the printing process. Contact force reduces the formation of wrinkles in the flexible substrate, thereby improving the quality of the finished product. When more than one force is acting on an object, in order for the object to remain stationary the forces must come to equilibrium. When forces are applied in different directions to flexible material, such as flexible substrate, the forces will come to equilibrium when they are acting on the material with equal magnitude in opposite directions. This will result in the flexible material assuming a shape consistent with a plane in which the opposing force vectors lie. Any disruption of the equilibrium requires the force necessary to change the direction of the existing opposing force vectors. The opposing forces will be referred to as tension force. When the force of disruption, which changes the direction of the opposing force vectors, is caused by a solid object, with which the flexible substrate come in contact, it will be referred to as contact force. That is, change of direction by contact with a solid object creates contact force. With an intention of creating contact force, an object with a convex shape is ideal, since a truly convex shape provides an infinite number of points of direction change.

An application where contact force is to be created between flexible substrate, with a width of up to five meters, and a support structure will result in a support structure with a convex profile. A convex profile provides parallel lines of direction change, which are perpendicular to the to the direction of the tension forces and parallel to the surface of the flexible substrate, with contact force being created at each change of direction.

Significant contact force is created even when the changes in direction are spaced along a substantially convex profile. A substantially convex support structure with flat regions supporting the flexible substrate so as to provide printing regions is one to which print heads and carriage can be easily adapted. For use with very porous flexible substrate it is preferable to have the flexible substrate elevated off the surface of the support structure to allow the excess print medium to pass through and away from the flexible substrate. This is accomplished by placing support bars or other support elements on the lines of direction change.

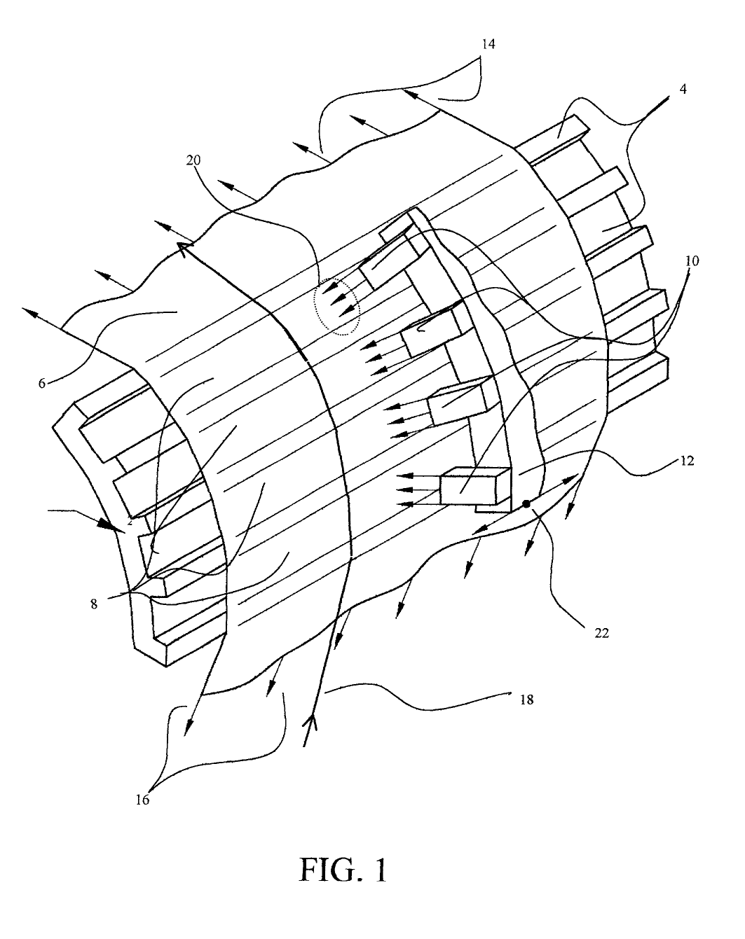

Referring now to the drawings, FIG. 1 shows a preferred embodiment of the present invention the support structure of which consists of parallel support bars 4 fixed on a frame 2. The flexible substrate 6 is placed upon the support structure following a feed path shown here by a vector 18 following the feed path and changes direction between the adjacent flat region in the sequence. Tension 14 and 16 is applied to the flexible substrate bi-directionally to the feed path, which causes the flexible substrate to stretch over the support structure thus creating contact force between the flexible substrate and the top surfaces of the support bars. As the flexible substrate is stretched over the support structure, flat printable regions 8 are created in the flexible substrate between the support bars of the support structure. Note that the vector 18 of the feed path changes direction between of each of the adjacent flat regions. Each of the print heads 10 defines a printing plane to which print a print medium is applied. Shown here are four print heads which is preferred for use with a four-color printing process. The support structure may also be configured for use with a minimum of two print heads as would be appropriate for use with a monochrome printing process. The printer carriage 12, which moves the print heads across the flexible substrate transversely to the feed path, and the print heads 10 are configured so as to align each of the print heads with the corresponding flat printable region over which the print head passes. Printing medium 20 may be applied to the flexible substrate as the print mechanism passes across the flexible substrate in either direction 22. It should be noted, that while the examples here and in the figures below show support structures with parallel support bars, any suitable support element including, but not limited to, rods and rollers may be used.

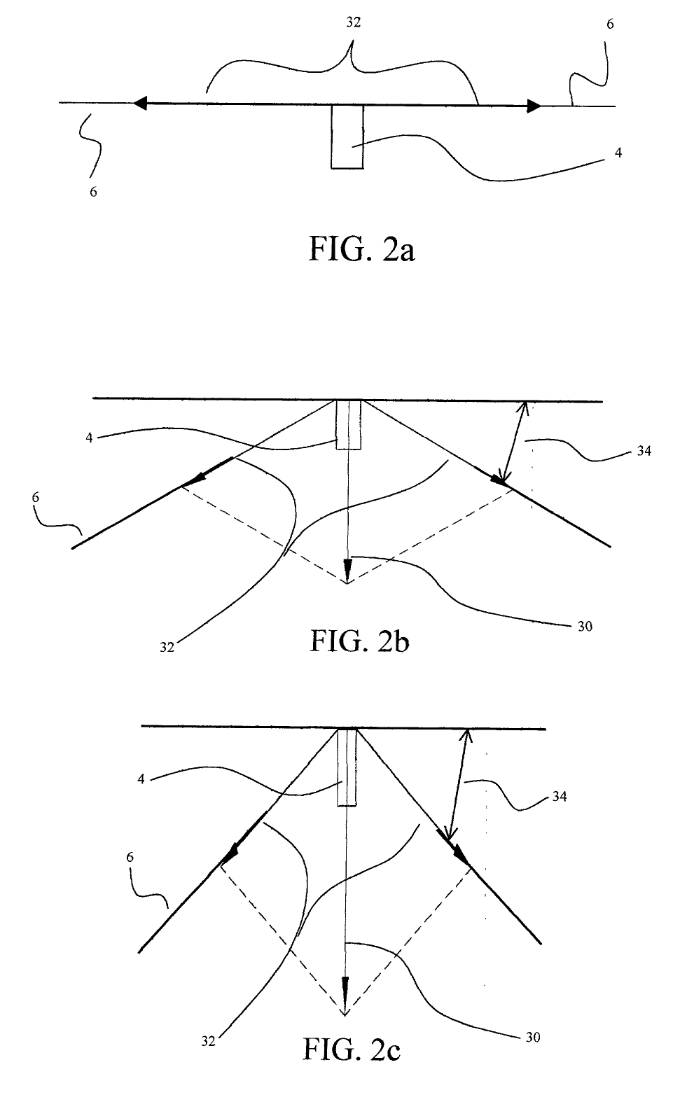

The diagrams in FIG. 2 are all numbered alike and depict the amount of contact force 30 between the flexible substrate 6 and the support element 4, as a function of the tension force 32 and the angle 34 at which the tension force is applied. FIG. 2a shows that when the tension force 32 is applied in linearly opposing directions, the angle of application being zero degrees, there is no contact force created between the flexible substrate and an the adjacent support element 4 as a result of the tension. A comparison of FIGS. 2b and 2c shows that the when the tension force 32 remains constant, the contact force 30 increase in relation to the angle 34 at which the tension force is applied. The larger the angle 34, the greater the contact force 30. A comparison of FIGS. 2b and 2d shows that when the angle 34 at which the tension force is applied remains constant, the contact force 30 increases in relation to the amount of tension force 32 applied. The greater the tension force 32, the greater the contact force 30.

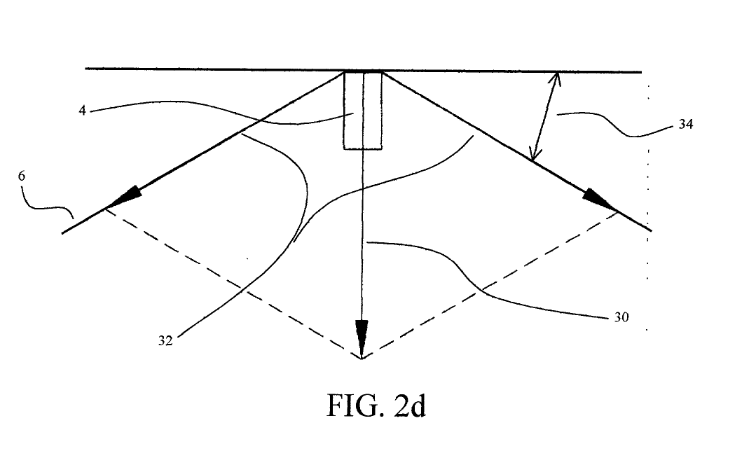

The FIGS. 3a and 3b show a practical application of the principles shown in FIG. 2 above. In FIG. 3a, the flexible substrate 6 is positioned on a flat printing table 40 of prior art currently in use. The tension force 32 is being applied in linearly opposite directions, so there is no contact force created by the tension force. In contrast, FIG. 3b shown a flexible substrate 6 positioned on a preferred embodiment of the present invention which supports the flexible substrate on support bars 4. The inset detail FIG. 3c, shows that the tension force is being applied at an angle 34, which creates contact force between the flexible substrate 6 and the support bar 4. This principle of creating contact force applies to each of the support bars 4 in the support structure. There is, therefore, contact force between the flexible substrate and the support structure at each point of contact between the two.

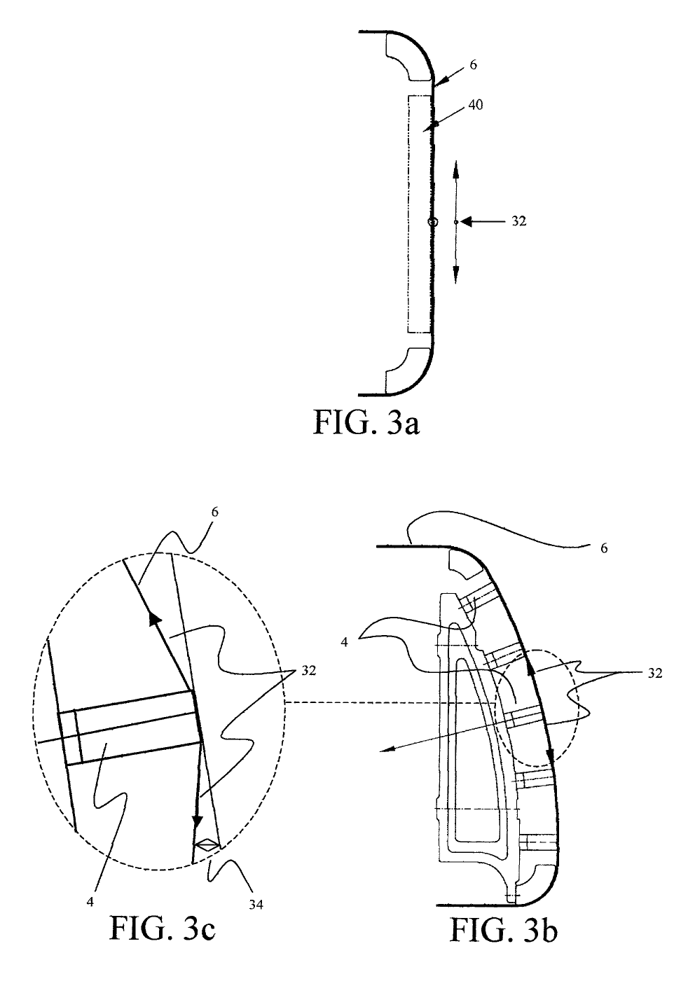

FIG. 4a shows an example of a flat printing table of prior art. Support bars 42 are fixed to a flat structural frame 40. There is no contact force created between the flexible substrate 6 and the printing table support bars 42 by tension applied to the flexible substrate, so wrinkles 44 may form. Wrinkles require the print heads 10 be positioned at a distance 46 from the flexible substrate, which allows for the height 48 (FIG. 4b) of the wrinkles 44, so as not to damage the print heads or smudge the output. FIG. 4b shows the height 48 of the wrinkle 44 across section A-A.

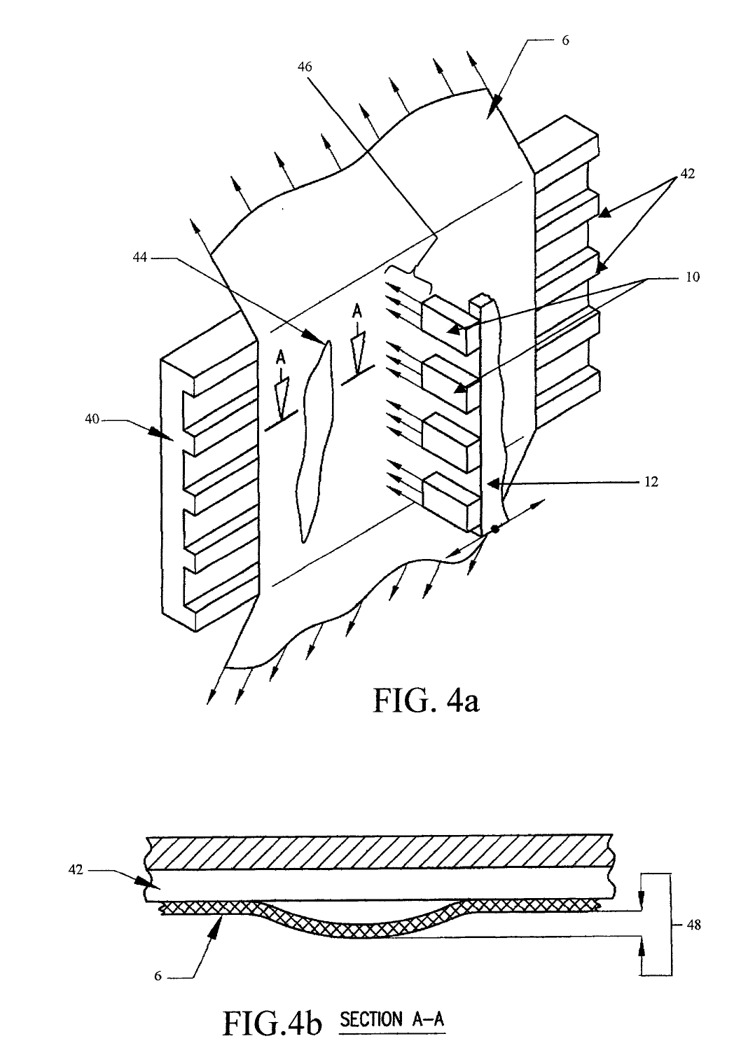

FIG. 5a (as a detail of FIG. 5) shows each of the print heads 54 and their respective printing planes 50 as the print media 52 is applied. Here, the flexible substrate is rendered as flat regions and the printing planes include the flat regions.

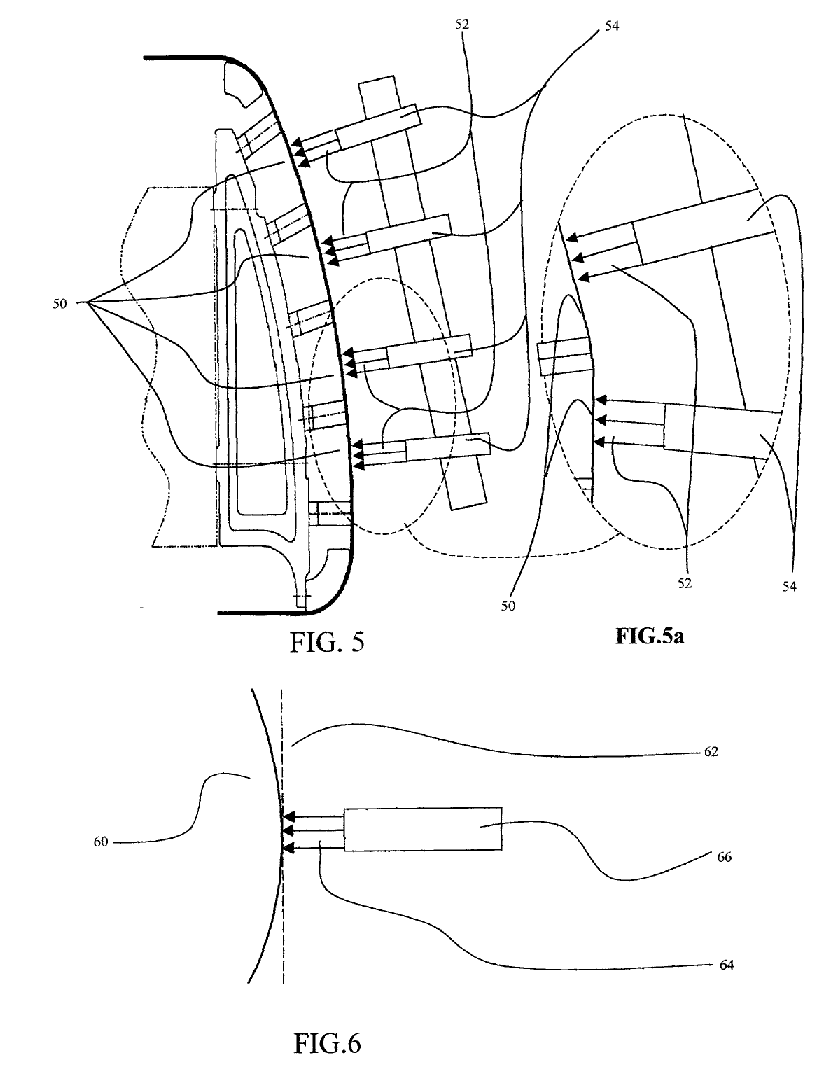

FIG. 6 shows the flexible substrate being rendered as a continuous curve 60. The printing plane 62, to which the print head 66 is applying a print medium 64, is tangential to the surface of the flexible substrate.

It should be noted that principles of the present invention detailed in FIGS. 5 and 6 are applicable to a full range of print heads including, but not limited to, scanning, and full width print heads.

It will be appreciated that the above descriptions are intended only to serve as examples, and that many other embodiments are possible within the spirit and the scope of the present invention.

What is claimed is:

1. A device upon which a flexible substrate is placed in order to be printed upon, the device being configured so as to create contact force between a supporting surface of the device and the flexible substrate, the device comprising:
(a) a support structure configured so as to render said flexible substrate as a plurality of adjacent flat regions, said flat regions being sequential along a feed path of said flexible substrate, each of said flat regions being positioned so that a vector following said feed path changes direction between said adjacent flat region in said sequence, said change of direction being a rotation about an axis that is perpendicular to said feed path and parallel to the surface of said flexible substrate, so that an entire surface of said plurality of flat regions, in combination, has a substantially convex profile; and
(b) a tensioning device configured so as to produce tension in said flexible substrate, said tension being along said feed path.

2. A device of claim 1, further comprising a digital printing device including a plurality of print heads, said support structure being configured so as to provide one said flat region for each of said printing heads.

3. A device of claim 2, wherein said printing device is a digital four color process printer using four said print heads and said support structure includes at least four said flat regions.

4. A device of claim 1, wherein said support structure includes parallel support bars positioned transversely to said feed path, said support bars at least partially delineating sides of said rectangles.

5. A device of claim 3, wherein said flat regions are created when said flexible substrate is placed upon said support structure, said flat regions being those portions of said flexible substrate that are stretched between said support bars.

6. A device of claim 1, wherein said support structure is a substantially continuous solid surface fabricated with a plurality of said flat regions.

7. A device of claim 1, wherein said tensioning device is integral to a feed and take-up device which moves said flexible substrate across said support structure.

8. A device for applying print media to a flexible substrate, the device comprising:
(a) a support structure configured so as to have a substantially convex profile onto which said flexible substrate is placed;
(b) a tensioning device configured so as to produce tension in said flexible substrate, said tension being along a feed path; and
(c) a plurality of print heads deployed so as to align each of said plurality of print heads with a corresponding printing region on said flexible substrate, said print heads defining a printing plane, said printing planes being rotated in relation to one another, said printing plane including said corresponding printing region.

9. The device of claim 8, wherein said support structure is configured so as to render said flexible substrate as a plurality of adjacent flat regions, said printing plane being coincidental with said flat region.

10. The device of claim 8, wherein said support structure is configured so as to render said flexible substrate as a substantially continuous curve, said printing plane being tangential to said curve.
